(19) United States
(12) Patent Application Publication
(10) Pub. No.: US 2026/0213594 A1
(43) Pub. Date: Jul. 23, 2026

(54) ROTOR ARRANGEMENT FOR AN ELECTRIC MACHINE, AND ELECTRIC MACHINE AND METHOD FOR COOLING A ROTOR

(71) Applicant: MERCEDES-BENZ GROUP AG, Stuttgart (DE)

(72) Inventors: Rainer PAULS, Vaihingen (DE); Georg SEIDEL, Stuttgart (DE); Caroline HAFFNER, Stuttgart (DE); Mike FUCHSLOCHER, Stuttgart (DE)

(21) Appl. No.: 19/140,679

(22) PCT Filed: Nov. 30, 2023
(86) PCT No.: PCT/EP2023/083847

§ 371 Date: Jun. 18, 2025

(30) Foreign Application Priority Data
Dec. 19, 2022 (DE) 10 2022 004 791.8

(51) Int. Cl. H02K 1/28; H02K 9/19

(52) U.S. Cl. CPC H02K 1/28; H02K 9/19

(57) ABSTRACT

A rotor arrangement for an electric machine includes a rotor and a spray device for spraying a coolant with a coolant outlet arranged with respect to the rotor such that a rotor face can be sprayed with the coolant. A baffle plate, which is fastened to the rotor, is shaped and is arranged on the rotor such that the coolant sprayed by the spray device can be caught by the baffle plate and guided on the rotor face.

### BACKGROUND AND SUMMARY OF THE INVENTION

Exemplary embodiments of the invention relate to a rotor arrangement for an electric machine having a rotor and a spray device for spraying a coolant with a coolant outlet, which is arranged with respect to the rotor such that a rotor face can be sprayed with the coolant, and to an electric machine with a rotor arrangement and to a method for cooling a rotor of an electric machine.

Electric machines having a rotor and a stator are known. During operation, the electric machine gets hot due to losses. These can be categorized as ohmic losses, iron losses, stray losses, and mechanical losses, for example. Iron losses occur primarily in the stator and rotor and contribute significantly to the total losses. If the electric machine gets too hot, it can be destroyed. Different cooling systems are therefore known in the prior art.

An electric machine with a rotor and with a stator is known from DE 10 2015 015 797 A1. The stator comprises at least one winding which has a surface facing the rotor, which surface can be sprayed with a cooling liquid in order to cool the winding, this cooling liquid being sprayed outwards in the radial direction by the rotor when the rotor is rotating, wherein the surface runs obliquely to the axial direction at least in a subregion.

WO 2022/001268 A1 discloses a motor with a motor cooling system for an electric vehicle. The motor has a rotor with a rotor iron core, a first end cover, and a second end cover, wherein provided in an end cover is a liquid flow duct fluidically connected to a liquid flow duct in the rotor iron core and facing a liquid outlet duct of a stator winding in the end cover. The liquid inlet duct, the liquid flow duct, and the liquid outlet duct form a rotor duct through which a coolant can flow.

Exemplary embodiments of the invention are directed to providing more effective cooling for an electric machine, in particular a rotor of the electric machine.

The invention is based on the idea of using a baffle plate to catch a coolant used for spray cooling and to guide it along a rotor face so that the contact time between coolant and rotor is improved and increased, thereby making cooling of the rotor more effective without the need for any complicated cooling duct structures.

One aspect of the invention relates to a rotor arrangement for an electric machine, having a rotor and a spray device for spraying a coolant with a coolant outlet, which is arranged with respect to the rotor such that a rotor face can be sprayed with the coolant. The rotor arrangement has a baffle plate. The baffle plate is fastened to the rotor, in particular rigidly fastened thereto, for example by welding. The baffle plate is shaped and arranged on the rotor such that the coolant sprayed by the spray device can be caught by the baffle plate and can be guided on the rotor face.

Convective transfer of heat between the rotor and the coolant can be improved by targeted guiding of a stream of the coolant onto the rotor face, which can also be referred to as rotor rear side or rotor disc surface, by means of the baffle plate. Without targeted guiding of the coolant by the baffle plate, only a considerably lower transfer of heat from the rotor face to the coolant can be achieved due to excessive atomization and jet reflection. By attaching the suitably designed baffle plate to the rotor rear side, the coolant can be kept and guided along the rotor face. By targeted guiding of the coolant on the rotor face, a contact time between the coolant and the rotor face can be extended and a heat transfer coefficient can be increased, in particular compared to air-cooled rotor arrangements. Consequently, a rotor can be cooled significantly more effectively due to the rotor arrangement according to the invention, which can increase the continuous output of the electric machine and/or make it possible to use more cost-effective magnet materials or adhesives and the like. This is possible, in particular, since the improved cooling of the rotor leads to a lower temperature at the magnets of the rotor and adhesives, whereby temperature requirements for the magnet materials and adhesives are lower.

In particular, the majority of the sprayed coolant, in particular more than 80%, in particular more than 90%, can be caught by the baffle plate. Due to rotational

forces, during operation of the electric machine the coolant is carried outwards, away from an axis of rotation of the rotor, over the rotor face and is held and guided by the baffle plate along the rotor face. If the coolant reaches the outer edge of the rotor, it can be ejected, for example, and fed to a cooling circuit. In particular, the baffle plate ensures that the majority of the rotor face covered by the baffle plate, in particular more than 80%, in particular more than 90%, in particular more than 95%, is wetted with the coolant. This then cools the rotor particularly effectively and efficiently, as the rotor can be cooled very well and with less coolant, for example. In addition, this also brings the advantage that effective cooling is possible with simple spray cooling without cooling ducts having a complicated design in or on the rotor.

Where mention is made of axial or radial direction, this is always to be understood hereinabove and hereinafter in relation to the axis of rotation of the rotor, unless stated otherwise. The coolant is in particular a cooling oil.

In particular, the spray device has a coolant supply and a pump in addition to the coolant outlet. In particular, the coolant outlet sprays the coolant in a jet that is between 0° and 90° in width, in other words has an opening angle of 0° to 90°.

According to the invention, the baffle plate has a guide part. The guide part has a zero-gap part. The zero-gap part covers the rotor face in the radial direction at least in some areas and tangentially circumferentially completely. The zero-gap part bears against the rotor face.

The zero-gap part is used to force very thin coolant, which can also be referred to as a cooling fluid film, onto the rotor surface using the high centrifugal forces occurring during operation. A gap size between the rotor face and the baffle plate is determined in this case only by the surface roughness and flatness of the rotor face and the baffle plate. In the zero-gap part, the gap size is therefore nominally 0, i.e., the zero-gap part bears against the rotor face. However, in truth, due to surface structures of the rotor face and the baffle plate, the gap size is large enough on a microscopic scale that the coolant can spread though.

It is possible that the zero-gap part directly adjoins the catching part.

Furthermore, it is possible that the zero-gap part directly adjoins the catching part and is designed radially up to the edge of the rotor. As a result, the coolant can be guided particularly well along most of the rotor side.

However, it is also possible that the zero-gap part directly adjoins the catching part and does not extend radially up to the edge of the rotor, in particular so that the zero-gap part covers less than 50%, in particular less than 30%, in particular less than 20%, of the rotor face. Particularly if the zero-gap part forms the entire guide part of the baffle plate, this arrangement can save weight and installation space.

In one exemplary embodiment, the baffle plate is designed to guide the coolant radially and tangentially circumferentially on the rotor face. As a result, the rotor can be cooled more effectively and more efficiently. Tangentially circumferentially means along a notional circle at a certain radius about the axis of rotation, which is smaller than a maximum outermost rotor radius. The notional circle lies on a plane perpendicular to the axis of rotation, for example on the rotor face. The direction can be clockwise or counter-clockwise. By way of example, the baffle plate can guide the coolant inside a circular ring area with the axis of rotation in the center both radially and tangentially circumferentially on the rotor face.

In one exemplary embodiment, the rotor face is arranged perpendicular to an axis of rotation of the rotor. In other words, a normal direction on the rotor face is parallel to the axis of rotation.

In particular, therefore, the rotor face arranged perpendicular to the axis of rotation of the rotor is cooled, and not necessarily a lateral surface of the rotor. This is particularly advantageous for electric machines, in which most of the heat arises at the rotor face, for example in axial flux machines.

In one exemplary embodiment, the baffle plate has a catching part. The catching part is raised in the axial direction of the rotor face. The catching part is open towards the axis of rotation in order to catch the coolant. The catching part is a part of the baffle plate that is arranged closest to the axis of rotation in the radial direction. The catching part is, in particular, further away from the axis of rotation in the radial direction than the coolant outlet since the coolant are carried radially outwards by the centrifugal forces.

In particular, the catching part is designed to be tangentially completely circumferential in order to prevent the coolant flowing past the catching part on the outside instead of between the catching part and rotor face.

In particular, the catching part is funnel-shaped and/or designed as a truncated cone or is truncated-cone-shaped. This means, in particular, that the catching part protrudes from the rotor face in the longitudinal section through the axis of rotation. This shape is particularly suitable for catching the coolant due to a wide opening angle and guiding it further on the rotor face. In particular, the opening angle in relation to the rotor face is between 10° and 60°.

In one exemplary embodiment, the guide part has an accumulation part.

The accumulation part does not bear against the rotor face. In particular, a gap size between the accumulation part and the rotor face is 0.1 mm to 1 mm. The accumulation part is arranged radially between the catching part and the zero-gap part.

The accumulation part serves to accumulate the coolant collected by the catching funnel. This increases the contact time between the coolant and the rotor face, so that there is an improved transfer of heat for cooling the rotor.

One possible design of the baffle plate, referred to as the full variant, has the following sections radially from the axis of rotation to the edge of the rotor: catching part, accumulation area, zero-gap area and, optionally, a mounting centering means.

The mounting centering means can be attached to a lateral surface of the rotor. It can be designed in particular to extend over the entire circumference, or only partially, in particular at at least three places.

By way of example, a radial extent of the individual sections varies depending on rotor topology and cooling requirements. Depending on the design, for example not all of the sections necessarily have to be present.

In one exemplary embodiment, the guide part has beads in the zero-gap part. The beads extend axially away from the rotor face. The beads run in the radial direction from the accumulation part partially, in particular only partially, therefore not completely, through the zero-gap part.

The course of the beads in the radial direction from the accumulation area partially through the zero-gap part is to be understood here to mean that the beads, viewed radially, are not designed to extend up to outer edge of the zero-gap part. The beads serve to improve a uniform distribution of coolant tangentially circumferentially on the rotor face. In the zero-gap part there can be unpredictable uneven gap sizes due to the unevenness of the baffle plate and the rotor face. This can result in uneven distribution of the coolant in the zero-gap part. In particular, the beads are distributed uniformly tangentially circumferentially around the rotor face, in particular in a star shape. The beads can accumulate the coolant and then discharge it uniformly tangentially circumferentially. This ensures that the rotor face can be cooled uniformly.

The guide part has support stubs in one region of the accumulation part.

The support stubs extend axially in the direction of the rotor face. The support stubs contact the rotor face.

In particular, the support stubs are adjacent to the accumulation part. A minimum distance between the accumulation part and the rotor face can be ensured by means of the support stubs. This makes the rotor arrangement more stable.

In particular, the baffle plate is welded to the rotor. In particular, the baffle plate is welded to the support stubs and/or the beads on the rotor, in particular exclusively welded thereto. In particular, the baffle plate is fixed on the rotor face by spot welding, for example in the zero-gap part and at the depressions in the accumulation part. In particular, the zero-gap part can be designed in an unobstructed state as a flat cone in order to achieve a defined contact pressure on the rotor face after the fixing.

A further aspect of the invention relates to an electric machine with a rotor arrangement. The rotor arrangement is designed to drive a vehicle as part of an electric drivetrain.

In one exemplary embodiment, the electric machine is designed as an axial flux machine.

In particular, the rotor arrangement is a rotor arrangement for an axial flux machine.

In an axial flux machine, the electric machine has an axial construction, for example by sandwiching a stator disc between two rotor discs. In particular, the stator disc is arranged on only one rotor disc. In the axial flux machine, the magnetic flux flows parallel to the axis of rotation of the rotor. Therefore, the build-up of heat in the axial flux machine is greater on the rotor face, which is perpendicular to the axis of rotation, than in a radial flux machine. In a radial flux machine, more heat is produced on a lateral surface of the rotor. Therefore, the rotor arrangement according to the invention is particularly advantageous for axial flux machines. In particular, the rotor face is a side of the rotor facing away from the stator. If there are two rotor discs, then there are in particular exactly two rotor faces, each of which are located on one rotor disc.

In particular, the axial flux machine is a drive-torque-providing component of an electric drivetrain, for example of a motor vehicle.

In particular, the rotor arrangement according to the invention also makes it possible to cool a radial flux machine.

A further aspect of the invention relates to a method for cooling a rotor of an electric machine, the method having the following steps:
spraying a coolant onto a rotor face of the rotor by a spray device with a coolant outlet;
catching the sprayed coolant by means of a baffle plate which is fastened to the rotor; and
guiding the caught coolant on the rotor face by the baffle plate.

In particular, the coolant is sprayed from a fixed housing part onto the rotor face to cool the rotor.

Further embodiments of the method according to the invention follow directly from the different designs of the rotor arrangement according to the invention, and the electric machine according to the invention, and vice versa. In particular, individual features and corresponding explanations and advantages with respect to the various embodiments of the rotor arrangement according to the invention, and the electric machine according to the invention, can be transferred analogously to corresponding embodiments of the method according to the invention. In particular, the rotor arrangement according to the invention, and the electric machine according to the invention, are designed for carrying out a method according to the invention. In particular, the rotor arrangement according to the invention, and the electric machine according to the invention, carries out the method according to the invention.

Further advantages, features and details of the invention become apparent from the following description of preferred exemplary embodiments and with reference to the drawings. The features and feature combinations mentioned above in the description and the features and feature combinations mentioned hereinafter in the description of the figures and/or shown on their in the figures can be used not only in the respectively given combination, but also in other combinations or in isolation, without departing from the scope of the invention.

### BRIEF DESCRIPTION OF THE DRAWING FIGURES

In the drawing:

FIG. 1 shows a schematic longitudinal sectional illustration of an exemplary embodiment of a rotor arrangement according to the invention;

FIG. 2 shows a schematic longitudinal sectional illustration of an exemplary embodiment of an axial flux machine with a rotor arrangement according to the invention;

FIG. 3 shows a schematic longitudinal sectional illustration of a further exemplary embodiment of a rotor arrangement according to the invention;

FIG. 4 shows a schematic longitudinal sectional illustration of a further exemplary embodiment of a rotor arrangement according to the invention;

FIG. 5 shows a schematic longitudinal sectional illustration of a further exemplary embodiment of a rotor arrangement according to the invention; and

FIG. 6 shows a schematic plan view of an exemplary embodiment of a rotor arrangement according to the invention.

### DETAILED DESCRIPTION

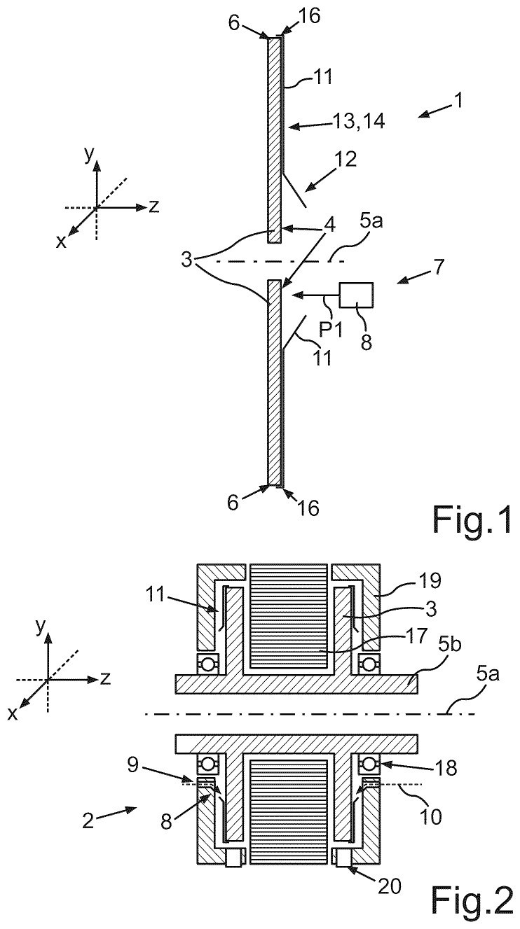

FIG. 1 shows a schematic longitudinal sectional illustration of an exemplary embodiment of a rotor arrangement 1 according to the invention. The rotor arrangement 1 has a rotor 3, a spray device 7 for spraying a coolant 10, and a baffle plate 11, so that, in particular, this involves active rotor cooling. The rotor 3 has a rotor face 4, which can also be referred to as rotor rear side, and a rotor lateral surface 6. The rotor face 4 is arranged perpendicular to an axis of rotation 5a and the rotor lateral surface 6 is arranged parallel to the axis of rotation 5a. The spray device 7 has a coolant outlet 8. From this, a coolant 10, in particular a cooling oil, can be sprayed onto the rotor face 4 in direction the arrows P1.

The baffle plate 11 has, in particular, a catching part 12 and a guide part 13. The guide part 13 has a zero-gap part 14. A gap size of the zero-gap part 14 relative to the rotor face 4 is determined by a surface roughness of the rotor face 4 and the baffle plate 11 in the zero-gap part 14. In particular, the zero-gap part 14 can also be referred to as zero-gap area and adjoins, in particular, the catching part 12 radially outwards as a ring which is parallel to the surface and bears against the rotor face 4. In the exemplary embodiment shown in FIG. 1, the zero-gap part 14 forms the whole guide part 13. The catching part 12 and the guide part 13 can cover the rotor face 4 completely tangentially circumferentially. An opening remains radially about the axis of rotation 5a into which the coolant 10 can be sprayed. A mounting centering means 16 can be arranged on the rotor lateral surface 6 adjoining the guide part 13. The mounting centering means 16 can be fastened completely circumferentially on the rotor lateral surface 6 or only partially, in particular at three or at least three places.

During operation of the rotor 3, the spray device 7 sprays the coolant 10 through the coolant outlet 8 in the direction of the arrows P1 onto the rotor face 4. Due to the shape, in particular the truncated cone shape of the catching part 12, the coolant 10, in particular the majority of the coolant 10, in particular more than 80% of the coolant 10, is caught and brought onto the rotor face 4. An opening angle of the catching part 12 in relation to the rotor face 4 is less than 90°, in particular between 10° and 60°. The microscopic gap size of the zero-gap part 14 is large enough that the coolant 10 is guided radially outwards through the zero-gap part 14 by centrifugal forces that prevail during operation. The coolant is ejected radially outwards, in particular over the entire circumference the rotor 3, at an outer edge of the rotor face 4 or at the rotor lateral surface 6.

FIG. 2 shows a schematic longitudinal sectional illustration of an exemplary embodiment of an axial flux machine 2 as an example of an electric machine with a rotor arrangement 1 according to the invention. In particular, the axial flux machine 2 can serve as a drive machine of an electric drivetrain for driving a predominantly or exclusively electrically driven vehicle. The axial flux machine 2 has, in particular two, rotor discs and one stator disc 17. The rotor faces 4 are arranged perpendicular to the axis of rotation 5a and to a side of the rotor discs that faces away from the stator disc 17. A bearing plate 19 is arranged on a rotor bearing 18. The construction and function of the baffle plate 11 correspond for example to the construction and function of the baffle plate 11 in FIG. 1.

The coolant 10 can be pumped through a coolant supply 9 to the coolant outlet 8. In this exemplary embodiment, the coolant supply 9 is guided through the bearing plate 19. In another exemplary embodiment, the coolant supply can also be guided inside a rotor shaft 5b of the rotor 3. By way of example, the coolant outlet 8, which can also be referred to as a nozzle, is angled, in particular at an angle radially outwards, in relation to the catching part 12. The rotor shaft 5b runs along the axis of rotation 5a. The coolant 10 is carried radially outwards by the centrifugal forces through the guide part 13 and ejected radially outwards towards the bearing plate 19 at the outer edge of the rotor face 4. The coolant 10 can flow downwards along the bearing plate 19 owing to gravity. The coolant 10 fed to a cooling circuit through a drainage hole 20. In particular, the coolant 10 is collected in an oil sump and cooled via an oil-water heat exchanger and then guided back to the rotor arrangement via pumps.

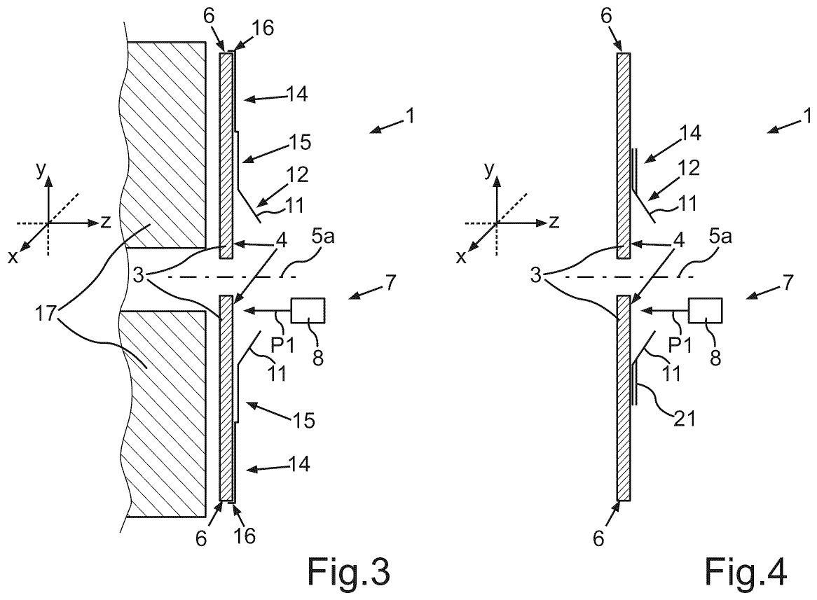

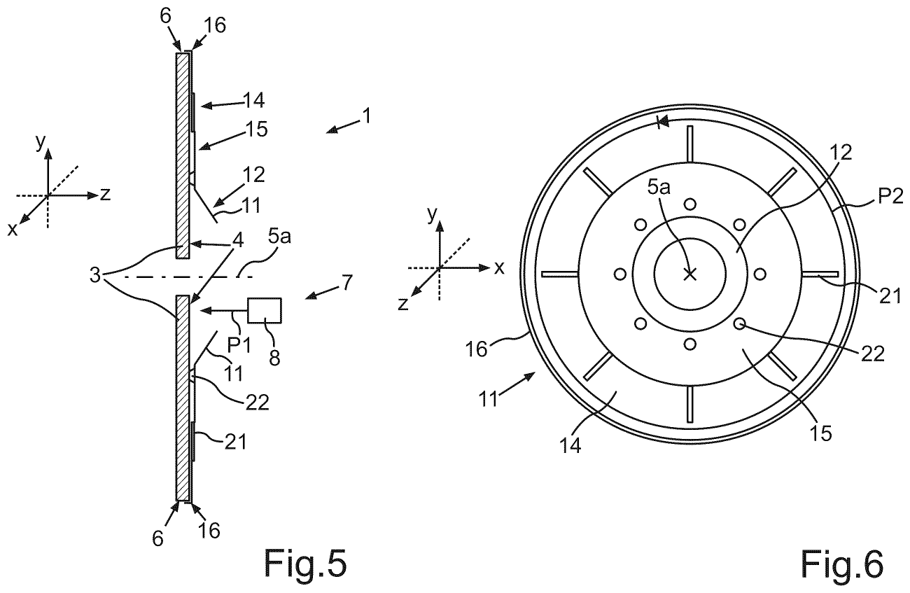

The figures, FIG. 1 and FIG. 3 up to and including FIG. 5, always show the same sectional perspective with different design variations of the baffle plate 11 arranged on the rotor 3. These sectional perspectives can be a partial view of FIG. 2, as indicated in FIG. 3 by the additional illustration of the stator disc 17 FIG. 3 shows a further exemplary embodiment of a rotor arrangement 1 according to the invention. In this exemplary embodiment, the guide part 13 has an accumulation part 15 in addition to the zero-gap part 14. The accumulation part 15 can be arranged between the catching part 12, which can also be referred to as a catching funnel, and the zero-gap part 14. In particular, the catching part 12 radially outwards adjoins a ring that is approximately surface-parallel to the rotor 3 and spaced apart from the rotor surface. This section of the baffle plate 11 referred to as accumulation part 15 serves to accumulate the coolant 10 collected by the catching part 12 10. The gap size between the rotor face 4 and baffle plate 11 is in particular 0.1 mm to 1 mm.

A further exemplary embodiment of a rotor arrangement 1 according to the invention is shown in FIG. 4. In this exemplary embodiment there is no mounting centering means 16 and the guide part 13 has only the zero-gap part 14 and no accumulation part 15. The guide part 13 is short in this exemplary embodiment and ends before the outer edge of the rotor face 4, in particular when viewed radially, inside the inner two thirds, in particular inside the inner half, of the rotor face 4. In particular, this exemplary embodiment has beads 21. The beads 21 are open radially outwards. As a result, the rotor face 4 can be wetted with the coolant 10 as a wall film after exiting beads.

FIG. 5 shows a further exemplary embodiment of a rotor arrangement 1 according to the invention. In this exemplary embodiment, the baffle plate 11 is shaped as described for FIG. 3. This exemplary embodiment additionally also has the beads 21 and support stubs 22. In particular, the radial beads 21 are embossed into the baffle plate 11 in the zero-gap part 14 and extend from the accumulation part 15 at least over a part of the zero-gap part 14. The beads 21 serve to ensure uniform distribution of the coolant 10. The support stubs 22 can be attached to the accumulation part 15 as embossings to maintain the gap size between the baffle plate 11 and the accumulation part 15. In particular, the baffle plate 11 is welded to the rotor face at the beads 21 and at the support stubs 22.

FIG. 6 shows an exemplary embodiment of a rotor arrangement according to the invention in a plan view of the axis of rotation 5a. The axis of rotation 5a is in this illustration oriented in the z-direction. In this exemplary embodiment, the baffle plate 11 is designed as in FIG. 5. The dashed arrow P2 points in a tangentially circumferential direction. The x-axis and the y-axis point in radial directions and the z-axis in an axial direction.

### LIST OF REFERENCE DESIGNATIONS

1 rotor arrangement
2 axial flux machine
3 rotor
4 rotor face
5a axis of rotation
5b rotor shaft
6 rotor lateral surface
7 spray device
8 coolant outlet
9 coolant supply
10 coolant
11 baffle plate
12 catching part
13 guide part
14 zero-gap part
15 accumulation part
16 mounting centering means
17 stator disc
18 rotor bearing
19 bearing plate
20 drainage hold
21 beads
22 support stubs
P1 arrow 1
P2 arrow 2

1-13. (canceled)

14. A rotor arrangement for an electric machine, the rotor arrangement comprising:
a rotor;
a spray device configured to spray a coolant, wherein the spray device includes a coolant outlet arranged with respect to the rotor such that a rotor face is sprayable with the coolant from the coolant outlet; and
a baffle plate fastened to the rotor, wherein the baffle plate is shaped and arranged on the rotor such that the coolant sprayed by the spray device is caught by the baffle plate and guided on the rotor face,
wherein the baffle plate has a guide part,
wherein the guide part has a zero-gap part covering at least some areas of the rotor face in a radial direction and covering the rotor tangentially circumferentially completely, wherein the zero-gap part bears against the rotor face.

15. The rotor arrangement of claim 14, wherein the baffle plate configured to guide the coolant radially on the rotor face.

16. The rotor arrangement of claim 14, wherein the rotor face is arranged perpendicular to an axis of rotation of the rotor.

17. The rotor arrangement of claim 16, wherein the baffle plate further comprises a catching part, wherein the catching part is
raised in an axial direction from the rotor face,
open towards the axis of rotation,
a part of the baffle plate arranged closest to the axis of rotation in the radial direction, and
further away from the axis of rotation in the radial direction than the coolant outlet.

18. The rotor arrangement of claim 17, wherein the guide part has an accumulation part, wherein the accumulation part does not bear against the rotor face and is arranged radially between the catching part and the zero-gap part.

19. The rotor arrangement of claim 18, wherein the guide part has support stubs in a region of the accumulation part, wherein the support stubs extend axially in a direction of the rotor face and contact the rotor face.

20. The rotor arrangement of claim 14, wherein the guide part has beads in the zero-gap part, wherein the beads extend axially away from the rotor face and run in the radial direction at least partially through the zero-gap part.

21. The rotor arrangement of claim 14, wherein the baffle plate has a mounting centring part extending on a rotor lateral surface at least partially over a circumference.

22. The rotor arrangement of claim 14, wherein the baffle plate is fixed to the rotor via spot welds in an area of the zero-gap part or in an area of the support stubs.

23. The rotor arrangement of claim 22, wherein the baffle plate has a shape in an unmounted state differing from a shape of the baffle plate in a mounted state, wherein the zero-gap area is truncated-cone-shaped to provide an axial preload of the baffle plate on the rotor.

24. An electric machine comprising:
a stator; and
a rotor arrangement comprising
a rotor;
a spray device configured to spray a coolant, wherein the spray device includes a coolant outlet arranged with respect to the rotor such that a rotor face is sprayable with the coolant from the coolant outlet; and
a baffle plate fastened to the rotor, wherein the baffle plate is shaped and arranged on the rotor such that the coolant sprayed by the spray device is caught by the baffle plate and guided on the rotor face,
wherein the baffle plate has a guide part,
wherein the guide part has a zero-gap part covering at least some areas of the rotor face in a radial direction and covering the rotor tangentially circumferentially completely, wherein the zero-gap part bears against the rotor face.

25. The electric machine of claim 24, wherein the electric machine is an axial flux machine.

26. A method for cooling a rotor of an electric machine having a rotor arrangement, the method comprising:
spraying, by a spray device with a coolant outlet, a coolant onto a rotor face of the rotor;
catching, by a baffle plate fastened to the rotor, the sprayed coolant; and
guiding, by the baffle plate, the caught coolant on the rotor face,
wherein the rotor arrangement comprises
a rotor;
a spray device configured to spray a coolant, wherein the spray device includes a coolant outlet arranged with respect to the rotor such that a rotor face is sprayable with the coolant from the coolant outlet; and
a baffle plate fastened to the rotor, wherein the baffle plate is shaped and arranged on the rotor such that the coolant sprayed by the spray device is caught by the baffle plate and guided on the rotor face,
wherein the baffle plate has a guide part,
wherein the guide part has a zero-gap part covering at least some areas of the rotor face in a radial direction and covering the rotor tangentially circumferentially completely, wherein the zero-gap part bears against the rotor face.
